(19) United States
(12) Patent Application Publication
(10) Pub. No.: US 2015/0143454 A1
(43) Pub. Date: May 21, 2015

(54) SECURITY MANAGEMENT APPARATUS AND METHOD

(71) Applicant: ELECTRONICS AND TELECOMMUNICATIONS RESEARCH INSTITUTE, Daejeon (KR)

(72) Inventors: Cheol Ho LEE, Daejeon (KR); Jung Min KANG, Daejeon (KR)

(21) Appl. No.: 14/466,969

(22) Filed: Aug. 23, 2014

(30) Foreign Application Priority Data
Nov. 18, 2013 (KR) 10-2013-0140030

(51) Int. Cl. H04L 29/06

(52) U.S. Cl. CPC H04L 63/145; H04L 63/20; H04L 63/0272; H04L 63/0281; H04L 63/0227
USPC 726/1; 726/23

(57) ABSTRACT

A security management apparatus and method are provided. The security management apparatus includes a user authentication unit, a packet inspection unit, a packet extraction unit, a file analysis unit, and an agent generation unit. The user authentication unit receives user information from a terminal of a user, and performs a user authentication procedure. The packet inspection unit inspects a packet based on rules, and transfers the inspected packet to a destination over the Internet. The packet extraction unit recognizes a specific protocol in a packet transferred to the destination or a packet returned from the destination and extracts a file based on the results of the recognition. The file analysis unit determines whether or not the extracted file is a malicious file. If the extracted file is the malicious file, the agent generation unit generates a malware removal agent, and removes malware by executing the malware removal agent.

### CROSS-REFERENCE TO RELATED APPLICATION

This application claims the benefit of Korean Patent Application No. 10-2013-0140030, filed Nov. 18, 2013, which is hereby incorporated by reference in its entirety into this application.

### BACKGROUND OF THE INVENTION

1. Technical Field

The present disclosure relates generally to a security management apparatus and method and, more particularly, to a security management apparatus and method that monitors a network packet generated by a user terminal or directed toward the user terminal when the user terminal sets a specific server as a proxy server or a virtual private network (VPN) server.

2. Description of the Related Art

In conventional network security management technology, security equipment, such as a firewall (F/W), an intrusion detection system (IDS) or an intrusion prevention system (IPS), is connected to the network line of a specific organization or company, intrusion is detected, and the results of the detection are handled.

For example, Korean Patent Application Publication No. 10-2002-0022740 entitled “Systems for Providing Internet Access Service” discloses a method of placing dedicated VPN access equipment in a subscriber network, connecting two or more public networks, and switching between the public networks depending on the fault of a line and the state of each VPN server.

That is, in conventional technology, security management is performed using VPN access equipment connected to multiple public networks, as in Korean Patent Application Publication No. 10-2002-0022740.

Currently, in the field of security, there is a need for technology in which a terminal can receive a security management service without dedicated VPN equipment.

### SUMMARY OF THE INVENTION

When a user of an organization or a company using a security management service moves out of the area of the organization or the company and uses his or her terminal, the terminal is placed in a control-blind spot because it cannot receive a security management service and thus a security threat to the terminal cannot be detected during the period in which the terminal is out of the control area. Accordingly, an object of the present invention is to provide an apparatus and method that are capable of security management over the terminal of a user regardless of the location of the user.

An organization or a company not equipped with security equipment (e.g., an F/W, an IDS, or an IPS) nor staffed with security-dedicated personnel for network security management is exposed to various types of security threats because it cannot receive a network security management service. Another object of the present invention is to provide an apparatus and method that are capable of security management even in a situation in which a network security management service is unable to be provided.

In accordance with an aspect of the present invention, there is provided a security management method, including receiving, by a security management apparatus, user information from a terminal of a user; performing a user authentication procedure by comparing the user information with information registered with a security management center; inspecting a packet, received from the terminal of the user, based on rules set by the security management center; and transferring the inspected packet to a destination over the Internet.

Performing the user authentication procedure may be performed by a proxy server or a VPN server that operates in conjunction with the security management apparatus.

Inspecting the packet may be performed by an intrusion detection system (IDS) or an intrusion prevention system (IPS).

In accordance with another aspect of the present invention, there is provided a security management method, including recognizing, by a security management apparatus, a specific protocol in an inbound and/or outbound packet, and extracting, by the security management apparatus, a file based on the results of the recognition; determining whether or not the extracted file is a malicious file; generating a malware removal agent corresponding to the extracted file if, as a result of the determination, it is determined that the extracted file is the malicious file; and removing malware by executing the malware removal agent.

The inbound packet may correspond to a packet transferred to an outside over the Internet, and the outbound packet may correspond to a packet returned from a destination.

Determining whether or not the extracted file is the malicious file may include, if, as a result of the determination, it is determined that the extracted file is the malicious file, obtaining a hash value of the extracted file and path information corresponding to the extracted file.

The security management method may further include, if a terminal of a user determined to download or upload malware sets up an HTTP connection, performing control so that code for display of a warning pop-up window is inserted into a corresponding HTTP response packet and the warning pop-up window is output to the terminal.

Removing the malware may include decrypting information included in the malware removal agent and searching for characteristics and derivative files of the malware; and performing control so that the characteristics and derivative files of the malware are removed from a terminal of a user.

In accordance with still another aspect of the present invention, there is provided a security management apparatus, including a user authentication unit configured to receive user information from a terminal of a user, and to perform a user authentication procedure by comparing the user information with information registered with a security management center; a packet inspection unit configured to inspect a packet received from the terminal of the user based on rules set by the security management center, and to transfer the inspected packet to a destination over the Internet; a packet extraction unit configured to recognize a specific protocol in a packet transferred to the destination or a packet returned from the destination, and to extract a file based on the results of the recognition; a file analysis unit configured to determine whether or not the extracted file is a malicious file; and an agent generation unit configured to, if, as a result of the determination, it is determined that the extracted file is the malicious file, generate a malware removal agent corresponding to the extracted file based on the results of the analysis of the file analysis unit and remove malware by executing the malware removal agent.

The user authentication unit may be executed in a proxy server or a VPN server that operates in conjunction with the security management apparatus.

The packet inspection unit may be executed in an intrusion detection system (IDS) or an intrusion prevention system (IPS).

The file analysis unit may be further configured to, if, as a result of the determination, it is determined that the extracted file is the malicious file, obtain a hash value of the extracted file and path information corresponding to the extracted file.

The security management apparatus may further include a display unit configured to, if the terminal of the user determined to download or upload malware sets up an HTTP connection, perform control so that code for display of a warning pop-up window is inserted into a corresponding HTTP response packet and the warning pop-up window is output to the terminal.

The agent generation unit may be further configured to decrypt information included in the malware removal agent, search for characteristics and derivative files of the malware, and perform control so that the characteristics and derivative files of the malware are removed from the terminal of the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an environment to which a security management apparatus according to an embodiment of the present invention is applied;

FIG. 2 is a diagram schematically illustrating the configuration of the security management apparatus according to an embodiment of the present invention;

FIG. 3 is a flowchart illustrating a security management method according to an embodiment of the present invention; and

FIG. 4 is a flowchart illustrating a process in which the security management apparatus extracts a file from a packet and generates a malware removal agent corresponding to the extracted file according to an embodiment of the present invention.

### DESCRIPTION OF THE PREFERRED EMBODIMENTS

Embodiments of the present invention are described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

A security management apparatus and method according to embodiments of the present invention are described in detail below with reference to the accompanying drawings.

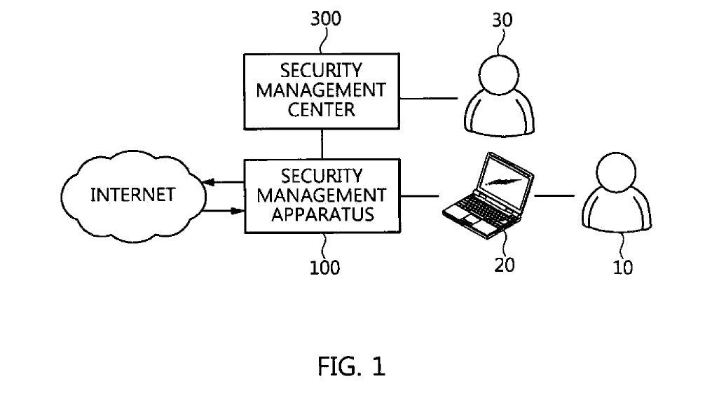

FIG. 1 is a diagram illustrating an environment to which a security management apparatus 100 according to an embodiment of the present invention is applied.

Referring to FIG. 1, the security management apparatus 100 enables the terminal 20 of a user 10 of an organization or a company not equipped with security equipment, such as an IDS or an IPS, nor staffed with security-dedicated personnel to be provided with the same control service as in the case where such security equipment and security-dedicated personnel are fully provided only through proxy configuration or VPN configuration.

Furthermore, the security management apparatus 100 detects whether or not malware is present by extracting and analyzing a download or upload file based on network packets that are transmitted and received between the Internet and the terminal 20 of the user 10 of the organization or the company not equipped with security equipment, such as an IDS or an IPS, nor staffed with security-dedicated personnel, and automatically generates a malware removal agent based on the results of the detection so that the user 10 may download the malware removal agent onto the terminal 20 and remove detected malware.

The security management apparatus 100 operates in conjunction with a security management center 300.

The security management center 300 enables a security specialist 30 to directly control the security management apparatus 100. For example, if an intrusion detection event occurs in the security management apparatus 100, the security management center 300 may perform control so that the security specialist 30 can deal with the intrusion detection event based on his or her final determination.

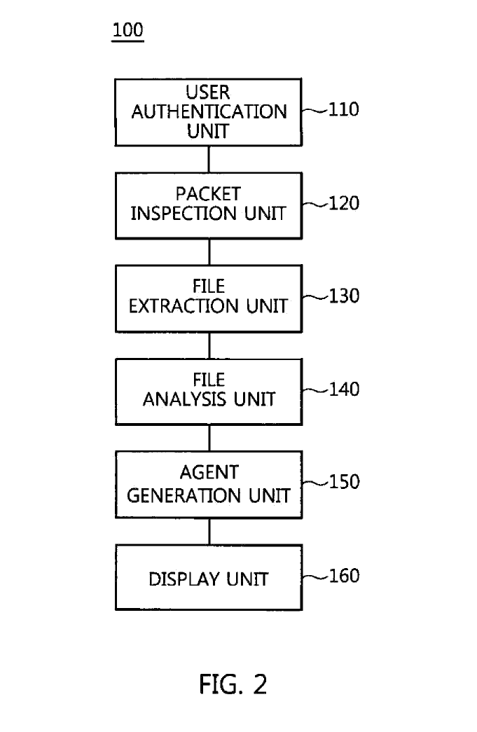

The security management apparatus 100 is described in detail below with reference to FIG. 2.

FIG. 2 is a diagram schematically illustrating the configuration of the security management apparatus according to an embodiment of the present invention.

Referring to FIG. 2, the security management apparatus 100 may include a user authentication unit 110, a packet inspection unit 120, a file extraction unit 130, a file analysis unit 140, an agent generation unit 150, and a display unit 160.

The security management apparatus 100 performs control so that the terminal 20 of the user 10 of an organization or a company not equipped with security equipment, such as an IDS or an IPS, nor staffed with security-dedicated personnel performs a user authentication procedure corresponding to the network traffic of the terminal 20 through proxy configuration or VPN configuration. In this case, the proxy configuration or VPN configuration is performed by a program that is basically or separately installed on the terminal 20.

The user authentication unit 110 performs a user authentication procedure when proxy configuration or VPN configuration is performed, and blocks the access of an unauthorized user through a user authentication procedure.

More specifically, the user authentication unit 110 receives user information, that is, the ID and password of a user, through the terminal of the user 20, and then performs a user authentication procedure by comparing the received user information with the IDs and passwords of users registered with the security management center 300.

Furthermore, if user information received through the terminal 20 of the user 10 is not identical to the user information registered with the security management center 300, the user authentication unit 110 blocks the access of the user 10.

The user authentication unit 110 according to an embodiment of the present invention may correspond to a proxy server or a VPN server, but is not limited thereto.

When proxy configuration or VPN configuration is performed, the user authentication unit 110 changes a tunneled network packet into a common packet whose tunneling has been released, and transfers the common packet to the packet inspection unit 120.

The packet inspection unit 120 receives a common packet from the terminal of a user who has been authenticated by the user authentication unit 110, and inspects the received packet based on rules set by the security management center 300. The packet inspection unit 120 transfers the inspected packet to a destination over the Internet.

In this case, the packet returned from the destination is inspected based on various intrusion detection rules when passing through the packet inspection unit 120, is changed into an encapsulated packet for tunneling by the user authentication unit 110, and is then transferred to the terminal of the user 20.

The packet inspection unit 120 according to an embodiment of the present invention may correspond to an IDS or an IPS, but is not limited thereto.

The file extraction unit 130 receives a packet transferred from the packet inspection unit 120 to the outside over the Internet, and a packet returned from a destination. In this case, the packet returned from the destination is transferred to the file extraction unit 130 using a separate network tap (not shown).

The file extraction unit 130 functions to recognize a specific protocol (e.g., an HTTP or an FTP) in an inbound and/or outbound packet and extract a transmitted or received file based on the results of the recognition. In this case, the inbound packet corresponds to a packet that is transferred from the packet inspection unit 120 to the outside over the Internet, and the outbound packet corresponds to a packet that is returned from a destination.

The file analysis unit 140 performs the static and dynamic analysis of a file extracted by the file extraction unit 130, and determines whether or not the extracted file is a malicious file based on the results of the analysis.

Furthermore, if the extracted file is determined to correspond to a malicious file as a result of the analysis, the file analysis unit 140 obtains the hash value of the extracted file and the path information of files that have been derivatively generated from the extracted file.

The agent generation unit 150 encrypts the information obtained by the file analysis unit 140, that is, the hash value of the extracted file and the path, in a specific format, for example, in an XML format, and generates a malware removal agent.

Once a generated malware removal agent has been executed, the agent generation unit 150 decrypts information included in the malware removal agent, and searches for the characteristics and derivative files of malware to be removed. Thereafter, the agent generation unit 150 performs control so that the characteristics and derivative files of the malware to be removed are removed from the terminal 20 of the user 10.

If the terminal of the user 20 determined to download or upload malware sets up an HTTP connection, HTM code that displays a warning pop-up window is inserted into a corresponding HTTP response packet, and is output to the terminal 20.

The display unit 160 displays a warning pop-up window, displays the reason why a file is suspected to be malware and information about the suspected file, and displays the URL path of the agent generation unit 150 that has generated a malware removal agent for the removal of the malware.

Accordingly, the user of the terminal 20 downloads the malware removal agent and then removes the malware from his or her terminal 20 according to the guidance of the warning pop-up window.

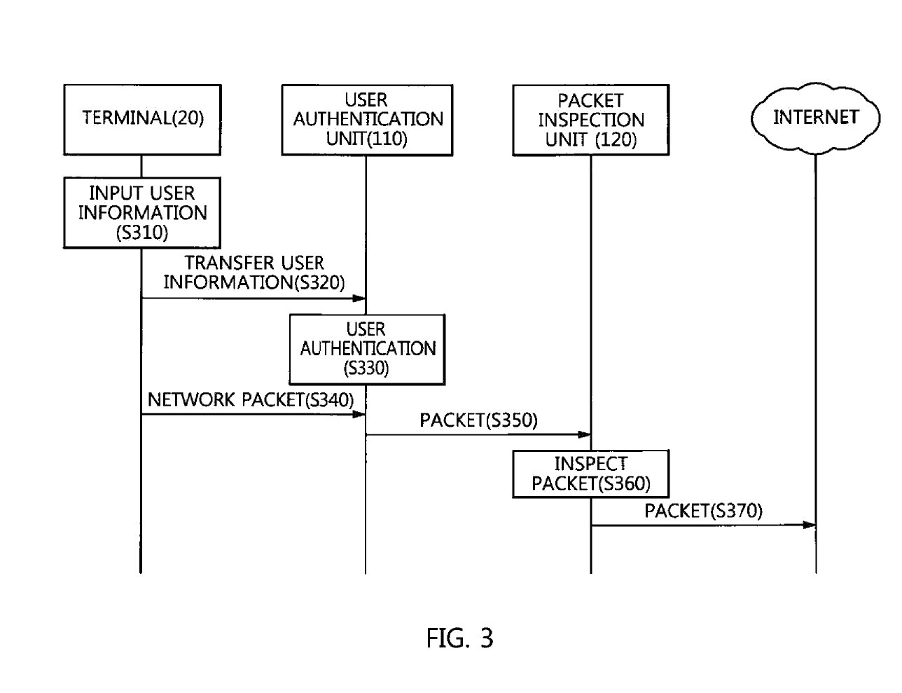

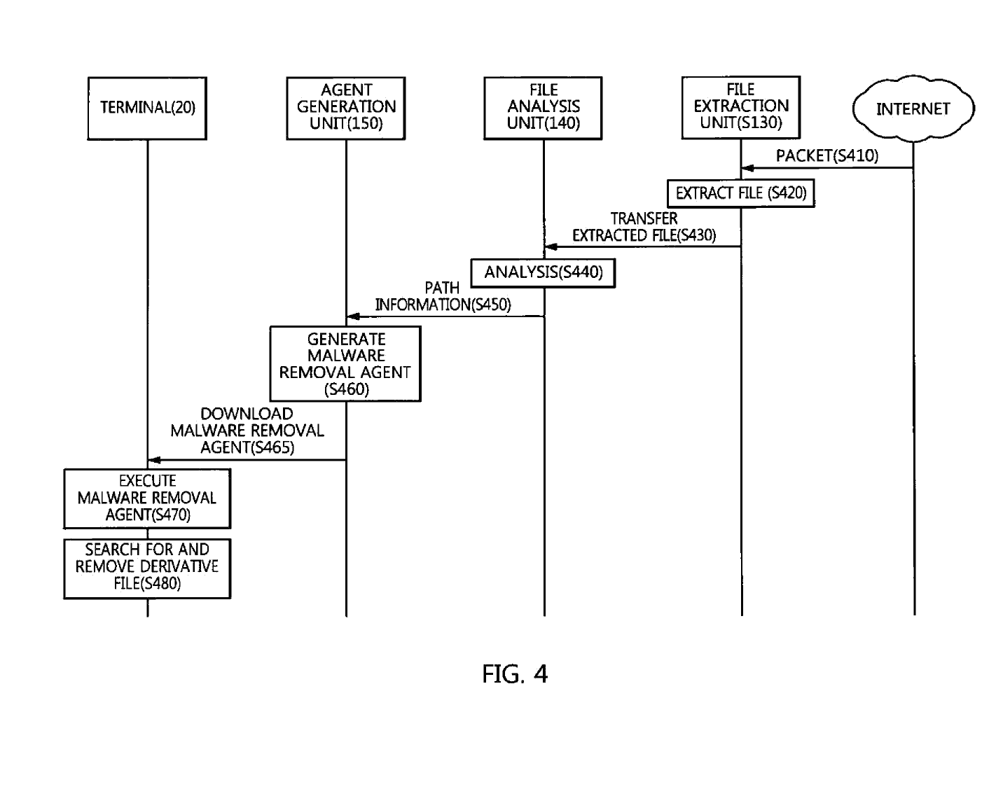

A security management method is described in detail below with reference to FIGS. 3 and 4.

FIG. 3 is a flowchart illustrating the security management method according to an embodiment of the present invention.

Referring to FIG. 3, the terminal 20 of the user 10 of the organization or the company not equipped with security equipment, such as an IDS or an IPS, nor staffed with security-dedicated personnel receives user information, that is, the ID and password of the user at step S310, and transfers the received user information to the user authentication unit 110 of the security management apparatus 100 at step S320.

The user authentication unit 110 performs a user authentication procedure by comparing the received user information with the IDs and passwords of users registered with the security management center 300 at step S330. In this case, if the received user information is not identical to the user information registered with the security management center 300, the user authentication unit 110 blocks the access of the user 10.

The user authentication unit 110 receives a tunneled network packet from the terminal 20 at step S340, and transfers a common packet whose tunneling has been released to the packet inspection unit 120 at step S350.

The packet inspection unit 120 inspects the received packet based on rules set by the security management center 300 at step S360.

Thereafter, the packet inspection unit 120 transfers the inspected packet to a destination over the Internet at step S370.

FIG. 4 is a flowchart illustrating a process in which the security management apparatus extracts a file from a packet and generates a malware removal agent corresponding to the extracted file according to an embodiment of the present invention.

Referring to FIG. 4, the file extraction unit 130 receives a packet returned from a destination over the Internet at step S410.

The file extraction unit 130 recognizes a specific protocol (e.g., an HTTP or an FTP) in the packet received at step S410, and extracts a transmitted or received file based on the results of the recognition at step S420. Furthermore, the file extraction unit 130 transfers the extracted file to the file analysis unit 140 at step S430.

The file analysis unit 140 performs the static and dynamic analysis of the file received at step S430, and determines whether or not the extracted file corresponds to a malicious file as a result of the analysis at step S440. If, as a result of the determination, it is determined that the extracted file corresponds to a malicious file, the file analysis unit 140 obtains the hash value of the extracted file and the path information of files that have been derivatively generated from the extracted file.

The file analysis unit 140 transfers the information about the hash value of the extracted file and the path of files that have been derivatively generated from the extracted file to the agent generation unit 150 at step S450.

The agent generation unit 150 encrypts the information about the hash value and path of the extracted file received at step S450, in a specific format, for example, in XML format, and generates a malware removal agent at step S460.

The terminal 20 downloads the malware removal agent, generated by the agent generation unit 150 at step S460, at step S465, executes the malware removal agent at step S470, decrypts information included in the malware removal agent, and searches for the characteristics and derivative files of the malware to be removed at step S480.

Thereafter, the agent generation unit 150 removes the malware while operating in conjunction with a terminal corresponding to the retrieved characteristics and derivative files of the malware at step S480. In this case, the display unit 160 displays a warning pop-up window, displays the reason why the file is suspected to be malware and information about the suspected file, and displays the URL path of the agent generation unit 150 that has generated the malware removal agent for the removal of the malware. Accordingly, the user of the terminal 20 downloads the malware removal agent and then removes the malware from his or her terminal 20 according to the guidance of the warning pop-up window.

As described above, the present invention is not limited to a conventional security management center dependent on a fixed network line, and provides a security management service using only a software method, such as proxy or VPN configuration. Accordingly, the present invention is expected to be significantly advantageous in that security management based on all user terminals, such as PCs and smart phones, can be achieved and a user terminal infected with malware can be automatically treated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A security management method, comprising:
receiving, by a security management apparatus, user information from a terminal of a user;
performing a user authentication procedure by comparing the user information with information registered with a security management center;
inspecting a packet, received from the terminal of the user, based on rules set by the security management center; and
transferring the inspected packet to a destination over an Internet.

2. The security management method of claim 1, wherein performing the user authentication procedure is performed by a proxy server or a virtual private network (VPN) server that operates in conjunction with the security management apparatus.

3. The security management method of claim 1, wherein inspecting the packet is performed by an intrusion detection system (IDS) or an intrusion prevention system (IPS).

4. A security management method, comprising:
recognizing, by a security management apparatus, a specific protocol in an inbound and outbound packet, and extracting, by the security management apparatus, a file based on results of the recognition;
determining whether or not the extracted file is a malicious file;
generating a malware removal agent corresponding to the extracted file if, as a result of the determination, it is determined that the extracted file is the malicious file; and
removing malware by executing the malware removal agent.

5. The security management method of claim 4, wherein the inbound packet corresponds to a packet transferred to an outside over an Internet, and the outbound packet corresponds to a packet returned from a destination.

6. The security management method of claim 4, wherein determining whether or not the extracted file is the malicious file comprises, if, as a result of the determination, it is determined that the extracted file is the malicious file, obtaining a hash value of the extracted file and path information corresponding to the extracted file.

7. The security management method of claim 4, further comprising, if a terminal of a user determined to download or upload malware sets up an HTTP connection, performing control so that code for display of a warning pop-up window is inserted into a corresponding HTTP response packet and the warning pop-up window is output to the terminal.

8. The security management method of claim 4, wherein removing the malware comprises:
decrypting information included in the malware removal agent and searching for characteristics and derivative files of the malware; and
performing control so that the characteristics and derivative files of the malware are removed from a terminal of a user.

9. A security management apparatus, comprising:
a user authentication unit configured to receive user information from a terminal of a user, and to perform a user authentication procedure by comparing the user information with information registered with a security management center;
a packet inspection unit configured to inspect a packet received from the terminal of the user based on rules set by the security management center, and to transfer the inspected packet to a destination over an Internet;
a packet extraction unit configured to recognize a specific protocol in a packet transferred to the destination or a packet returned from the destination, and to extract a file based on results of the recognition;
a file analysis unit configured to determine whether or not the extracted file is a malicious file; and
an agent generation unit configured to, if, as a result of the determination, it is determined that the extracted file is the malicious file, generate a malware removal agent corresponding to the extracted file based on results of the analysis of the file analysis unit and remove malware by executing the -malware removal agent.

10. The security management apparatus of claim 9, wherein the user authentication unit is executed in a proxy server or a virtual private network (VPN) server that operates in conjunction with the security management apparatus.

11. The security management apparatus of claim 9, wherein the packet inspection unit is executed in an intrusion detection system (IDS) or an intrusion prevention system (IPS).

12. The security management apparatus of claim 9, wherein the file analysis unit is further configured to, if, as a result of the determination, it is determined that the extracted file is the malicious file, obtain a hash value of the extracted file and path information corresponding to the extracted file.

13. The security management apparatus of claim 9, further comprising a display unit configured to, if the terminal of the user determined to download or upload malware sets up an HTTP connection, perform control so that code for display of a warning pop-up window is inserted into a corresponding HTTP response packet and the warning pop-up window is output to the terminal.

14. The security management apparatus of claim 9, wherein the agent generation unit is further configured to decrypt information included in the malware removal agent, search for characteristics and derivative files of the malware, and perform control so that the characteristics and derivative files of the malware are removed from the terminal of the user.
